(19) United States
(12) Patent Application Publication
(10) Pub. No.: US 2013/0041920 A1
(43) Pub. Date: Feb. 14, 2013

(54) FINDING RELATIONSHIPS AND HIERARCHIES USING TAXONOMIES

(71) Applicants: John P. Bufe, Neshanic Station, NJ (US); Samuel A. Kaufmann, Chappaqua, NY (US); Ian W. Webster, Scarsdale, NY (US); Margaret A. Zagelow, Morgan Hill, CA (US)

(72) Inventors: John P. Bufe, Neshanic Station, NJ (US); Samuel A. Kaufmann, Chappaqua, NY (US); Ian W. Webster, Scarsdale, NY (US); Margaret A. Zagelow, Morgan Hill, CA (US)

(73) Assignee: INTERNATIONAL BUSINESS MACHINES CORPORATION, Armonk, NY (US)

(21) Appl. No.: 13/205,456

(22) Filed: Aug. 8, 2011

(51) Int. Cl. G06F 17/30

(52) U.S. Cl. 707/777; 707/E17.098

(57) ABSTRACT

Provided are techniques for creating a hierarchy of results. An unstructured result set is received. Each result in the unstructured result set is hashed into a preliminary result set. For each hashed result, one or more related concepts are obtained using one or more taxonomies; one or more matches between the one or more related concepts and other hashed results in the preliminary result set are found; a candidate group for the hashed result is formed, wherein the candidate group includes the hashed result and one or more other hashed results based on the one or more matches; in response to determining that a frequency associated with the hashed result exceeds a threshold, the candidate group associated with that hashed result is compared with pre-existing groups that are in use; and, based on the comparing, one or more suggestions regarding the candidate group are provided.

### BACKGROUND

Embodiments of the invention relate to finding relationships and hierarchies between results (e.g., words and phrases) using taxonomies.

A user may enter a query to search for information. A search engine may produce words and phrases that are semantically and hierarchically related, but, which are not categorized as such. Currently, a user manually determines which concepts are semantically related from the words and phrases.

### SUMMARY

Provided are a method, computer program product, and system for creating a hierarchy of results. An unstructured result set is received. Each result in the unstructured result set is hashed into a preliminary result set. For each hashed result in the preliminary result set, one or more related concepts are obtained using one or more taxonomies; one or more matches between the one or more related concepts and other hashed results in the preliminary result set are found; a candidate group for the hashed result is formed, wherein the candidate group includes the hashed result and one or more other hashed results based on the one or more matches; in response to determining that a frequency associated with the hashed result exceeds a threshold, the candidate group associated with that hashed result is compared with pre-existing groups that are in use; and, based on the comparing, one or more suggestions regarding the candidate group are provided.

### BRIEF DESCRIPTION OF THE SEVERAL VIEWS OF THE DRAWINGS

Referring now to the drawings in which like reference numbers represent corresponding parts throughout:

FIG. 1 illustrates, in a block diagram, a computing device in accordance with certain embodiments.

FIGS. 2A and 2B illustrate logic, in a flow diagram, performed by the result grouping engine to process unstructured results to form grouped result sets in accordance with certain embodiments.

FIG. 3 illustrates, in a block diagram, grouped result sets in accordance with certain embodiments.

FIG. 4 illustrates, in a block diagram, a computer architecture that may be used in accordance with certain embodiments.

### DETAILED DESCRIPTION

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

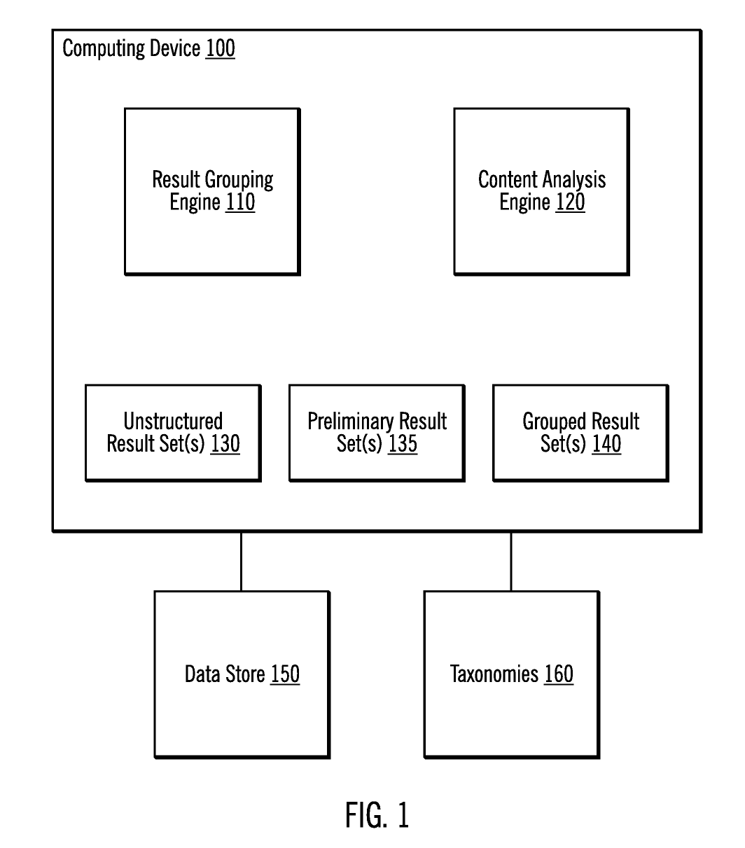

FIG. 1 illustrates, in a block diagram, a computing device 100 in accordance with certain embodiments. The computing device 100 includes a result grouping engine 110, a content analysis engine 120, one or more unstructured result sets 130, one or more preliminary result sets 135, and one or more grouped result sets 140. The grouped results sets 140 may be hierarchically related (e.g., with sub-groups and super-groups). An unstructured result set 130 may be described as a listing of words and phrases that does not indicate relationships between those words and phrases.

The computing device 100 is coupled to a data store 150 and to one or more taxonomies 160. In certain embodiments, each result is a word or phrase. In certain embodiments, the data store 150 stores documents, and the unstructured result sets are formed based on words and phrases in the documents.

A taxonomy 160 may be described as a collection of terms that contains the relationships between those terms. The taxonomies 160 may include external and/or customizable taxonomies. Each taxonomy 160 may be local to the computing device 100 or may be located at a different computing device. A taxonomy 160 at a different computing device may be referred to as an external taxonomy 160.

In certain embodiments, when a query issued against the data store 100, the content analysis engine 120 returns an unstructured result set 130, in response to the query. Then, the result grouping engine 110 creates one or more grouped result sets 140 from the unstructured result set 130.

The result grouping engine 110 organizes concepts extracted from unstructured text to automatically find relationships and hierarchies using external taxonomies

The result grouping engine 110 for scanning of results (e.g., words and phrases) produced by the content analysis engine 120 and provides an automated generation of hierarchical structures based on external and customizable taxonomies 160.

When a user generates a query to search using the content analysis engine 120, the content search engine 120 produces an unstructured result set 130 (e.g., words and phrases) from documents identified in the data store 150.

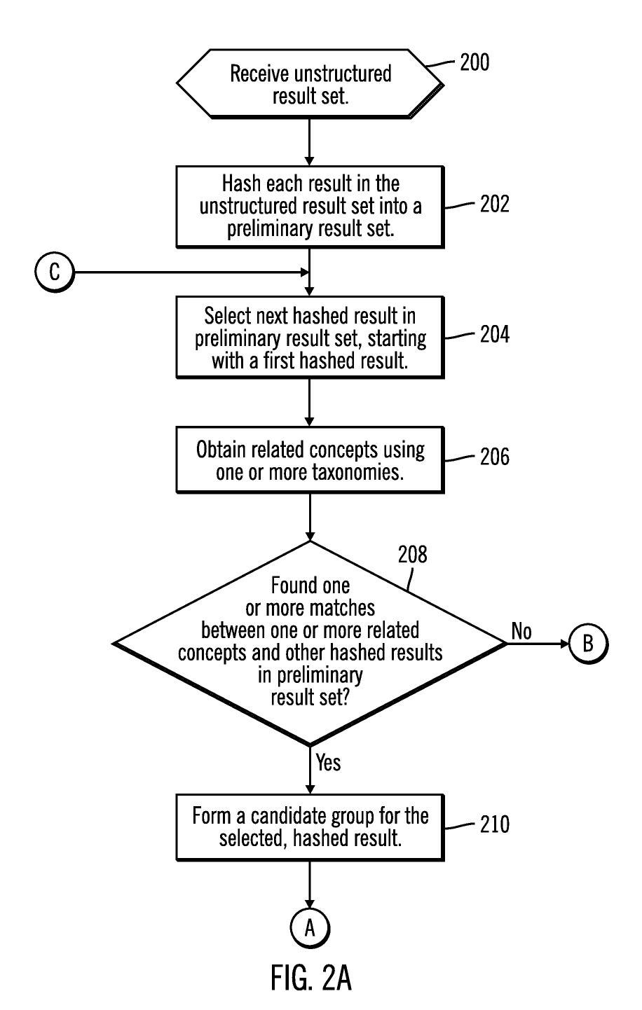

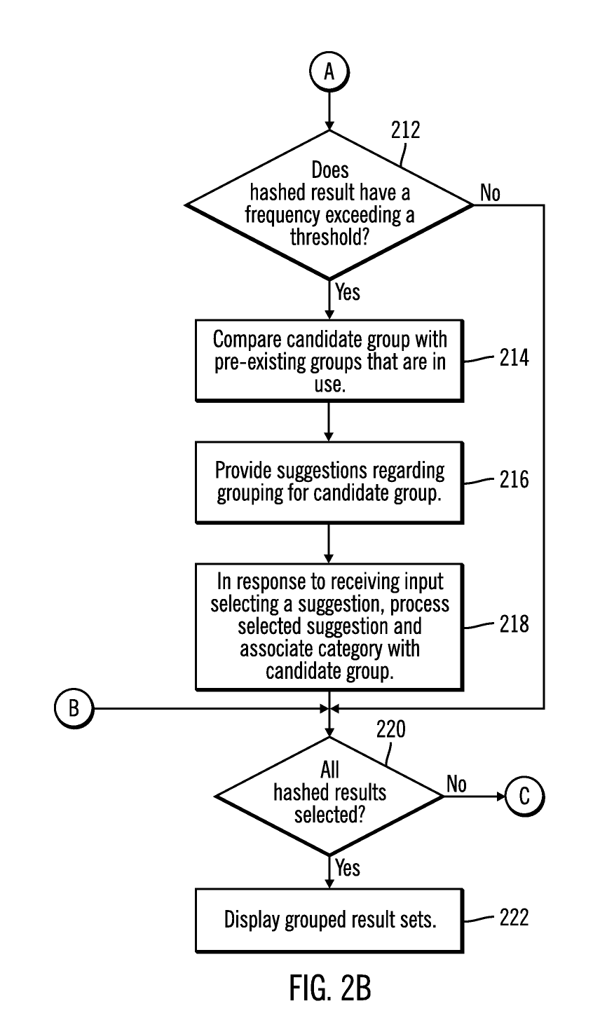

FIGS. 2A and 2B illustrate logic, in a flow diagram, performed by the result grouping engine 110 to process unstructured results 130 to form grouped result sets 140 in accordance with certain embodiments. Control begins at block 200 with the result grouping engine 110 receiving an unstructured result set 130. In particular, the content analysis engine 120 passes the unstructured result set 130 (e.g., words and phrases) to the result grouping engine 110. In block 202, the result grouping engine 110 hashes each result (e.g., a word or a phrase) in the unstructured result set 130 into a preliminary result set 135. In certain embodiments, the resulting term is considered a facet value, and the hash of the term is used for optimizing comparison and removing duplicates.

In block 204, the result grouping engine 110 selects a next hashed result in the preliminary result set 135, starting with a first hashed result. In block 206, the result grouping engine 110 obtains related concepts (e.g., related terms or synonyms) using one or more taxonomies 160. In certain embodiments, the result grouping engine 110 compares the hashed result in the preliminary result set 135 to the external and/or customized taxonomies 160. Each taxonomy comparison returns a set of related concepts based on the given hashed result, which is used to search across the rest of the preliminary result set 135 to find matches.

In block 208, the result grouping engine 110 determines whether one or more matches have been found between one or more related concepts and other hashed results in the preliminary result set 135. If so, processing continues to block 210, otherwise, processing continues to block 220 (FIG. 2B).

In block 210, the result grouping engine 110 forms a candidate group for the selected, hashed result. The candidate group includes the selected hashed result and the matching hashed results form the preliminary set 135. In certain embodiments, the result grouping engine 110 creates a new candidate group for each hashed result that has all related hashed results (e.g., words and phrases) that were present in the preliminary result set 135 and maintains the frequencies of how often that hashed result was matched. A frequency may be described as a total count of how many times the words in the group showed up in the result set. For example, if the result set was [A, B, C, B, D] and the group was [A, B, D], the frequency count would be 4. From block 210 (FIG. 2A), processing continues to block 212 (FIG. 2B).

In block 212, the result grouping engine 110 determines whether the hashed result has a frequency exceeding a threshold. If so, processing continues to block 214, otherwise, processing continues to block 220.

In block 214, the result grouping engine 110 compares the candidate group of the hashed result with pre-existing groups that are in use (i.e., not other candidate groups). That is, if the frequency of the hashed result is low, then the comparison is not performed. In certain embodiments, the comparison takes into account the percentage that the candidate and pre-existing groups match and the status of each preexisting group to determine the appropriate suggestion. In certain embodiments, the status is either “active”, “suggested”, or “ignored”, and the result grouping engine 110 provides different suggestions based on this status.

In block 216, the result grouping engine 110 provides suggestions regarding grouping (e.g., to a user or application) for the candidate group. In certain embodiments, the suggestions indicate: the candidate group should be created as a new group independent of other groups, that the candidate group should be created as a sub-group of another group, that the candidate group should be created as a super-group that includes at least one other group, that the candidate group should be ignored, or that a hashed result should be added to an existing group (without forming a new group).

In block 218, the result grouping engine 110, in response to receiving input selecting a suggestion, processes the selected suggestion (e.g., creates a sub-group or super-group) and associates a category with the candidate group. Processing the selected suggestion may include using the candidate to create a new group independent of other groups, using the candidate to create a sub-group of another group, using the candidate to create a super-group that includes at least one other group, or adding the hashed result to an existing group (without forming a new group). In certain embodiments, the candidate group may fall into three categories: active (i.e., in use), suggested, or ignored. The active category is used to describe a group that is in use. For example, the user indicated that the group is to be created and is using that group. The suggested category is used to describe a group that is automatically generated by the result grouping engine 110, but no action has been taken on that group by the user. The ignored category is used to describe a group that is not being used, and the result grouping engine 110 will not propose this group again for this user. In certain embodiments, the user may indicate that this group may be ignored.

In block 220, the result grouping engine 110 determines whether all hashed results in the preliminary result set 135 have been selected. If so, processing continues to block 222, otherwise, processing continues to block 204 (FIG. 2A) to select the next hashed result.

In block 222, the result grouping engine 110 provides (e.g., displays) grouped result sets. In certain embodiments, the grouped result sets are displayed with hierarchical structure.

With each query that is run, the result grouping engine 110 may pass a list of facet values to any number of related concept generators. Each concept generator generates related concepts using a taxonomy 160. When the group of related concepts is returned for each facet value, the result grouping engine 110 compares the related concepts against the rest of the list of facet values to see if there are any matches. The matches are then placed into a group and compared against previously generated groups that are in use. This can result in the newly formed group being suggested as a new group, a subgroup of an existing group, or a super-group of an existing group (giving the hierarchical structure). In certain embodiments, the result grouping engine 110 runs as a background process and runs a single facet value through the process at a time while comparing by hashing.

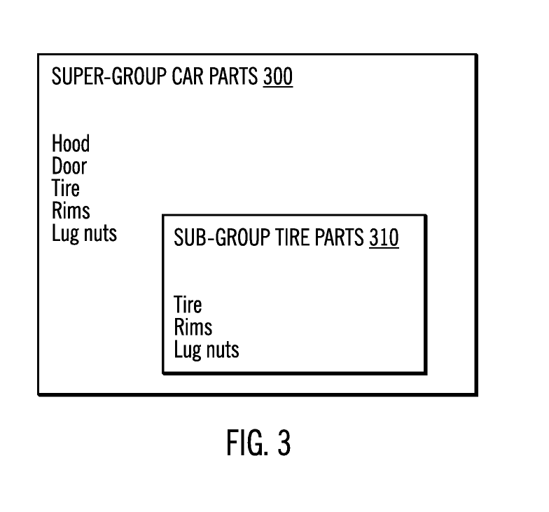

FIG. 3 illustrates, in a block diagram, grouped result sets 140 in accordance with certain embodiments. Assume that a query for “car parts” is issued. The content analysis engine 120 provides the following unstructured results 130:
Hood
Door
Tire
Rims
Lug nuts

The result grouping engine 110 processes the unstructured results 130 for “car parts” to create a super-group of “car parts” 300, which includes all of the unstructured results, and a sub-group of “tire parts” 310, which includes results that are related to tires.

The result grouping engine 110 obtains grouped result sets 140 by understanding aggregate frequencies and correlations for related terms, words, and phrases.

In certain embodiments, the result grouping engine 110 enhances the ability of the content analysis engine 120 to link de-facto between facet values (e.g., words and phrases) that are semantically related. The result grouping engine 110 provides automatic generation of semantically, hierarchical structures based on external and customizable taxonomies as a result of a scanning of the facet values.

In certain embodiments, the result grouping engine 110 scans words and phrases produced by the content analysis engine 120 and automatically generates hierarchical groups based on external and/or customizable taxonomies 160. The result grouping engine 110 organizes related concepts extracted from unstructured text to automatically find relationships and hierarchies using the external and/or customized taxonomies 160.

### Additional Embodiment Details

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, solid state memory, magnetic tape or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the embodiments of the invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational processing (e.g., operations or steps) to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The code implementing the described operations may further be implemented in hardware logic or circuitry (e.g., an integrated circuit chip, Programmable Gate Array (PGA), Application Specific Integrated Circuit (ASIC), etc. The hardware logic may be coupled to a processor to perform operations.

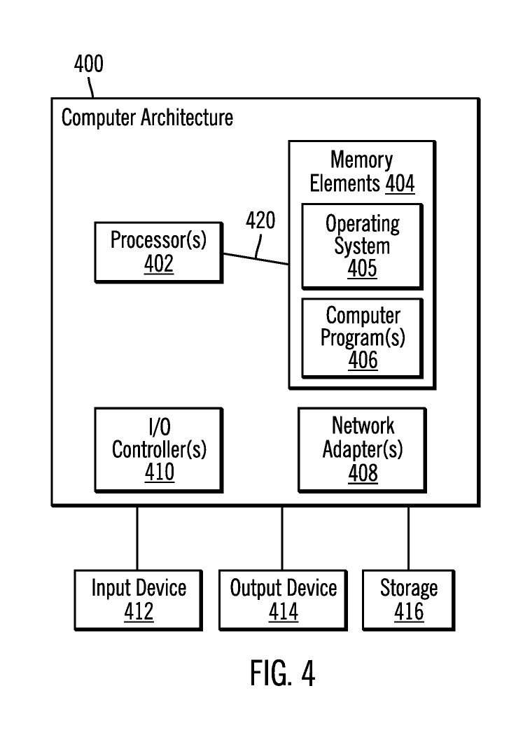

FIG. 4 illustrates a computer architecture 400 that may be used in accordance with certain embodiments. Computing device 100 or any other computer system may implement computer architecture 400. The computer architecture 400 is suitable for storing and/or executing program code and includes at least one processor 402 coupled directly or indirectly to memory elements 404 through a system bus 420. The memory elements 404 may include local memory employed during actual execution of the program code, bulk storage, and cache memories which provide temporary storage of at least some program code in order to reduce the number of times code must be retrieved from bulk storage during execution. The memory elements 404 include an operating system 405 and one or more computer programs 406.

Input/Output (I/O) devices 412, 414 (including but not limited to keyboards, displays, pointing devices, etc.) may be coupled to the system either directly or through intervening I/O controllers 410.

Network adapters 408 may also be coupled to the system to enable the data processing system to become coupled to other data processing systems or remote printers or storage devices through intervening private or public networks. Modems, cable modem and Ethernet cards are just a few of the currently available types of network adapters 408.

The computer architecture 400 may be coupled to storage 416 (e.g., a non-volatile storage area, such as magnetic disk drives, optical disk drives, a tape drive, etc.). The storage 416 may comprise an internal storage device or an attached or network accessible storage. Computer programs 406 in storage 416 may be loaded into the memory elements 404 and executed by a processor 402 in a manner known in the art.

The computer architecture 400 may include fewer components than illustrated, additional components not illustrated herein, or some combination of the components illustrated and additional components. The computer architecture 400 may comprise any computing device known in the art, such as a mainframe, server, personal computer, workstation, laptop, handheld computer, telephony device, network appliance, virtualization device, storage controller, etc.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of embodiments of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

The foregoing description of embodiments of the invention has been presented for the purposes of illustration and description. It is not intended to be exhaustive or to limit the embodiments to the precise form disclosed. Many modifications and variations are possible in light of the above teaching. It is intended that the scope of the embodiments be limited not by this detailed description, but rather by the claims appended hereto. The above specification, examples and data provide a complete description of the manufacture and use of the composition of the embodiments. Since many embodiments may be made without departing from the spirit and scope of the invention, the embodiments reside in the claims hereinafter appended or any subsequently-filed claims, and their equivalents.

1. A method for creating a hierarchy of results, comprising:
receiving, using a processor of a computer device, an unstructured result set;
hashing each result in the unstructured result set into a preliminary result set; and
for each hashed result in the preliminary result set,
obtaining one or more related concepts using one or more taxonomies;
finding one or more matches between the one or more related concepts and other hashed results in the preliminary result set;
forming a candidate group for the hashed result, wherein the candidate group includes the hashed result and one or more other hashed results based on the one or more matches;
in response to determining that a frequency associated with the hashed result exceeds a threshold, comparing the candidate group associated with that hashed result with pre-existing groups that are in use; and
based on the comparing, providing one or more suggestions regarding the candidate group.

2. The method of claim 1, further comprising:
providing grouped result sets with a hierarchical structure.

3. The method of claim 1, wherein the suggestion comprises one of: a suggestion that the candidate group should be created as a new group independent of other groups, a suggestion that the candidate group be created as a sub-group of another group, a suggestion that the candidate group be created as a super-group that includes at least one other group, a suggestion that the candidate group be ignored, and a suggestion that the hashed result be added to an existing group without forming a new group.

4. The method of claim 1, wherein the comparison takes into account a percentage that the candidate and pre-existing groups match and a status of each preexisting group to determine the suggestion.

5. The method of claim 1, further comprising:
receiving input selecting a suggestion from the one or more suggestions;
processing the selected suggestion; and
associating a category with the candidate group.

6. The method of claim 5, wherein the category comprises one of active, suggested, and ignored.

7. The method of claim 1, wherein the taxonomies include at least one of external taxonomies and customized taxonomies.

8. A computing device for creating a hierarchy of results, comprising:
a processor; and
a storage device connected to the processor,
wherein the storage device has stored thereon a program, and
wherein the processor is configured to execute instructions of the program to perform operations, wherein the operations comprise:
receiving an unstructured result set;
hashing each result in the unstructured result set into a preliminary result set; and
for each hashed result in the preliminary result set,
obtaining one or more related concepts using one or more taxonomies;
finding one or more matches between the one or more related concepts and other hashed results in the preliminary result set;
forming a candidate group for the hashed result, wherein the candidate group includes the hashed result and one or more other hashed results based on the one or more matches;
in response to determining that a frequency associated with the hashed result exceeds a threshold, comparing the candidate group associated with that hashed result with pre-existing groups that are in use; and
based on the comparing, providing one or more suggestions regarding the candidate group.

9. The system of claim 8, wherein the operations further comprise:
providing grouped result sets with a hierarchical structure.

10. The system of claim 8, wherein the suggestion comprises one of: a suggestion that the candidate group should be created as a new group independent of other groups, a suggestion that the candidate group be created as a sub-group of another group, a suggestion that the candidate group be created as a super-group that includes at least one other group, a suggestion that the candidate group be ignored, and a suggestion that the hashed result be added to an existing group without forming a new group.

11. The system of claim 8, wherein the comparison takes into account a percentage that the candidate and pre-existing groups match and a status of each preexisting group to determine the suggestion.

12. The system of claim 8, wherein the operations further comprise:
receiving input selecting a suggestion from the one or more suggestions;
processing the selected suggestion; and
associating a category with the candidate group.

13. The system of claim 12, wherein the category comprises one of active, suggested, and ignored.

14. The system of claim 8, wherein the taxonomies include at least one of external taxonomies and customized taxonomies.

15. A computer program product for creating a hierarchy of results, the computer program product comprising:
a computer readable storage medium having computer readable program code embodied therewith, the computer readable program code comprising:
computer readable program code, when executed by a processor of a computing device, configured to perform:
receiving an unstructured result set;
hashing each result in the unstructured result set into a preliminary result set; and
for each hashed result in the preliminary result set,
obtaining one or more related concepts using one or more taxonomies;
finding one or more matches between the one or more related concepts and other hashed results in the preliminary result set;
forming a candidate group for the hashed result, wherein the candidate group includes the hashed result and one or more other hashed results based on the one or more matches;
in response to determining that a frequency associated with the hashed result exceeds a threshold, comparing the candidate group associated with that hashed result with pre-existing groups that are in use; and
based on the comparing, providing one or more suggestions regarding the candidate group.

16. The computer program product of claim 15, wherein the computer readable program code, when executed by the processor of the computing device, is configured to perform:
providing grouped result sets with a hierarchical structure.

17. The computer program product of claim 15, wherein the suggestion comprises one of: a suggestion that the candidate group should be created as a new group independent of other groups, a suggestion that the candidate group be created as a sub-group of another group, a suggestion that the candidate group be created as a super-group that includes at least one other group, a suggestion that the candidate group be ignored, and a suggestion that the hashed result be added to an existing group without forming a new group.

18. The computer program product of claim 15, wherein the comparison takes into account a percentage that the candidate and pre-existing groups match and a status of each preexisting group to determine the suggestion.

19. The computer program product of claim 15, wherein the computer readable program code, when executed by the processor of the computing device, is configured to perform:
receiving input selecting a suggestion from the one or more suggestions;
processing the selected suggestion; and
associating a category with the candidate group.

20. The computer program product of claim 19, wherein the category comprises one of active, suggested, and ignored.
